(19) United States
(12) Patent Application Publication
(10) Pub. No.: US 2025/0144618 A1
(43) Pub. Date: May 8, 2025

(54) BIOCHEMICAL TEST MODULE AND MANUFACTURING METHOD THEREOF

(71) Applicant: APEX BIOTECHNOLOGY CORP., HSINCHU (TW)

(72) Inventors: YI-SHENG LIN, HSINCHU CITY (TW); CHI-YANG PENG, HSINCHU COUNTY (TW); NAI-JUI CHUEH, HSINCHU COUNTY (TW); CHENG-CHE WEN, HSINCHU CITY (TW); TANG-CHING KUAN, HSINCHU CITY (TW)

(21) Appl. No.: 18/405,100

(22) Filed: Jan. 5, 2024

(30) Foreign Application Priority Data
Nov. 3, 2023 (TW) 112142545

(51) Int. Cl. B01L 3/00

(52) U.S. Cl. CPC B01L 3/5023; B01L 2300/0816; B01L 2300/0861; B01L 2300/0887

(57) ABSTRACT

The present disclosure provides a biochemical test module. The biochemical test module includes a first reaction piece and a second reaction piece. The first reaction piece includes a first substrate; a first separator located on the first substrate and having a first flow channel exposing at least a portion of the first substrate; and a first cover covering the first separator. The first hole is connected with a first channel. The first reaction piece has a perforated structure penetrating the first cover, the first separator and the first substrate. The second reaction piece is disposed on one side of the first reaction piece adjacent to the first substrate and includes a second substrate; a second separator located on the second substrate and having a second flow channel exposing at least a portion of the second substrate; and a second cover covering the second separator and joined to the first substrate.

### CROSS-REFERENCE TO RELATED APPLICATIONS

This application claims priority to Taiwan Pat. Application No. 112142545 filed Nov. 3, 2023, the disclosure of which is hereby incorporated by reference in its entirety.

### TECHNICAL FIELD

The present application relates to a biochemical test module and a method for manufacturing the same.

### BACKGROUND

Recently, metabolism-related diseases have gradually become a common disease of modern people as a result of the increasing aging of the population and the long-term neglect of good dietary habits by modern people due to heavy workloads; examples of such metabolism-related diseases include diabetes, cardiovascular disease and hypertension. Therefore, the in vitro medical measurements plays an extremely important role in the medical industry nowadays, and the use of home-based clinical testing devices to measure changes in biological fluids is one of the common testing methods today, which can provide index information for rapid diagnosis of disease and treatment. Most of the common biosensing test chips on the market are for single-function tests. When a test subject needs to obtain multiple test data, it is required to purchase two or more biosensing test chips for testing different samples and perform the tests in order to obtain two different concentrations, which may increase the problem of the test subject having to take samples multiple times and having to have multiple types of measuring instruments.

Prior arts disclose electrochemical test chips with dual reaction zones. A sample enters two different sample chambers from a single sampling port, and the two sample chambers are used to measure the same sample concentration or different sample concentrations independently. However, forming two samples on the same substrate not only increases the difficulty in manufacturing and the cost of production, but also causes inaccurate measurement result due to interference of currents of the two samples during the measurement.

In addition, another prior art has two reaction zones on the same test chip; although the two reaction zones are separated by a compartmentalized structure, the two reaction zones still interfere with each other's signals during the measurement.

The “prior art” discussion above merely provides a technology background without acknowledging that the “prior art” discussed above reveal the subject matter of this disclosure and do not constitute prior art at this time, and that any of the “prior art” discussion above should not be regarded as any part of the present application.

### SUMMARY OF THE DISCLOSURE

One aspect of the present disclosure provides a biochemical test module. The biochemical test module includes a first reaction piece and a second reaction piece. The first reaction piece includes: a first substrate; a first separator, located on the first substrate and having a first flow channel exposing at least a portion of the first substrate; and a first cover, covering the first separator and having a first hole in connection with the first flow channel. The first reaction piece has a perforated structure penetrating the first cover, the first separator and the first substrate, and the perforated structure is separated from the first flow channel and the first hole. The first reaction piece has a first viewing zone configured for viewing a portion of the first flow channel via the first cover or the first hole. The second reaction piece is disposed in adjacent to one side of the first reaction piece of the first substrate. The second reaction piece includes: a second substrate; a second separator, located on the second substrate and having a second flow channel exposing at least a portion of the second substrate; and a second cover, covering the second separator and joined to the first substrate, and having a second hole. The second flow channel is in connection with the perforated structure via the second hole. The second reaction piece has a second viewing zone configured for viewing a portion of the second flow channel via the second cover or the second hole.

One aspect of the present disclosure provides another biochemical test module. The biochemical test module includes a first reaction piece and a second reaction piece. The first reaction piece includes: a first substrate, having a first surface and a second surface opposite to the first surface; a first separator, located on the first surface and having a first flow channel; and a first cover, covering the first separator and having a first hole in connection with the first flow channel. The first reaction piece has a perforated structure penetrating the first cover, the first separator and the first substrate. The second reaction piece includes: a second substrate, having a third surface and a fourth surface opposite to the third surface, the third surface facing the second surface; a second separator, located on the fourth surface and having a second flow channel; and a second cover, covering the second separator and having second hole. The second hole is in connection with the second flow channel.

Another aspect of the present disclosure provides a method for manufacturing a biochemical test module. The method includes: providing a first reaction piece, which includes: a first substrate, having a first surface and a second surface opposite to the first surface; a first separator, located on the first surface and having a first flow channel exposing a first portion of the first substrate; and a first cover, covering the first separator and having a first hole in connection with the first flow channel; forming a perforated structure penetrating the first cover, the first separator and the first substrate; aligning a second sampling port of a second reaction piece with a first sampling port of the first reaction piece, wherein the second reaction piece includes: a second substrate; a second separator, located on the second substrate and having a second flow channel exposing a second portion of the second substrate; a second cover, having a third surface covering the second separator and a fourth surface opposite to the third surface, and having a second hole in connection with the second flow channel, wherein the second flow channel is in connection with the perforated structure via the second hole; and attaching the second reaction piece to the first reaction piece.

### BRIEF DESCRIPTION OF THE DRAWINGS

Aspects of the present disclosure are best understood from the following detailed description and claims when read with the accompanying figures. It is noted that, elements with the same reference numbers are the same elements.

FIG. 1 is an exploded schematic diagram illustrating a biochemical test module according to some embodiments of the present disclosure.

FIG. 2 is a cross-sectional view of the biochemical test module according to the embodiment shown in FIG. 1 taken along the line L-L′.

FIG. 3 is a cross-sectional view illustrating a biochemical test module according to some embodiments of the present disclosure.

FIG. 4 is a cross-sectional view illustrating a biochemical test module according to some other embodiments of the present disclosure.

FIG. 5 and FIG. 6 are schematic diagrams illustrating a biochemical test module according to some embodiments of the present disclosure during use.

FIG. 7 is a top view of the biochemical test module according to the embodiment shown in FIG. 6 after sample filling.

FIGS. 8a to 8j are top views of the second viewing zone of the biochemical test module according to the embodiment shown in FIG. 6 when the sample is not filled.

FIG. 9 is a flow chart illustrating the manufacturing process of a biochemical test module according to some embodiments of the present disclosure.

FIGS. 10 to 12 are cross-sectional views of the various manufacturing stages illustrated in the manufacturing method according to FIG. 9.

### DETAILED DESCRIPTION

Detailed description of the present disclosure is discussed in detail below. However, it should be understood that the embodiments provide many inventive concepts that can be applied in a variety of specific contexts. The specific embodiments discussed are illustrative of the specific ways they can be made and used and do not limit the present disclosure's scope.

The same reference numeral is configured to represent the same elements/components in the various drawings and illustrative embodiments. Reference will now be made in detail to the illustrative embodiments shown in the drawings. Whenever possible, the same reference numeral is used in the drawings and the specification to represent the same or similar parts. In the drawings, the shape and thickness may be exaggerated for clarity and convenience. The description will be directed specifically to the elements forming part of, or more directly cooperating with, the device disclosed hereunder. As could be appreciated, elements not explicitly shown or described may take various forms. The reference to “some embodiments” or “embodiment” throughout this specification implies that the particular features, structures, or characteristics described in conjunction with the embodiment are included in at least one of the embodiments. Therefore, the phrase “in some embodiments” or “in an embodiment” appearing in various places throughout this specification does not necessarily refer to the same embodiment. Besides, the specific features, structures, or characteristics may be combined in any suitable manner in one or more embodiments.

In the drawings, the same reference numeral is configured to indicate the same or similar elements in the various views, and illustrative embodiments of the present application are shown and described. The drawings are not necessarily drawn to scale, and in some cases, the drawings have been exaggerated and/or simplified and are configured for illustrative purposes only. Many possible applications and variations of the present application will be understood by those of ordinary skill in the art in view of the following illustrative embodiments of the present disclosure.

Unless otherwise defined, all terms used herein, including technical and scientific terms, have the same meanings as those commonly understood by a person having ordinary skill in the art in the field of the disclosed embodiments. It should be understood, for example, that terms defined in common dictionaries should be construed to have meanings consistent with their meanings in the relevant field and context of this disclosure and should not be construed or understood to have meanings that are too formal unless expressly defined herein.

Besides, the following embodiments are provided to illustrate the core value of this disclosure but are not intended to limit the scope of protection of this disclosure. For clarity and ease of understanding, the same or similar functions or elements among this disclosure's different embodiments are not repeated or shown in the drawings. Besides, different elements or technical features from different embodiments may be combined or substituted to create further embodiments that are still covered by this disclosure, provided they do not conflict with each other.

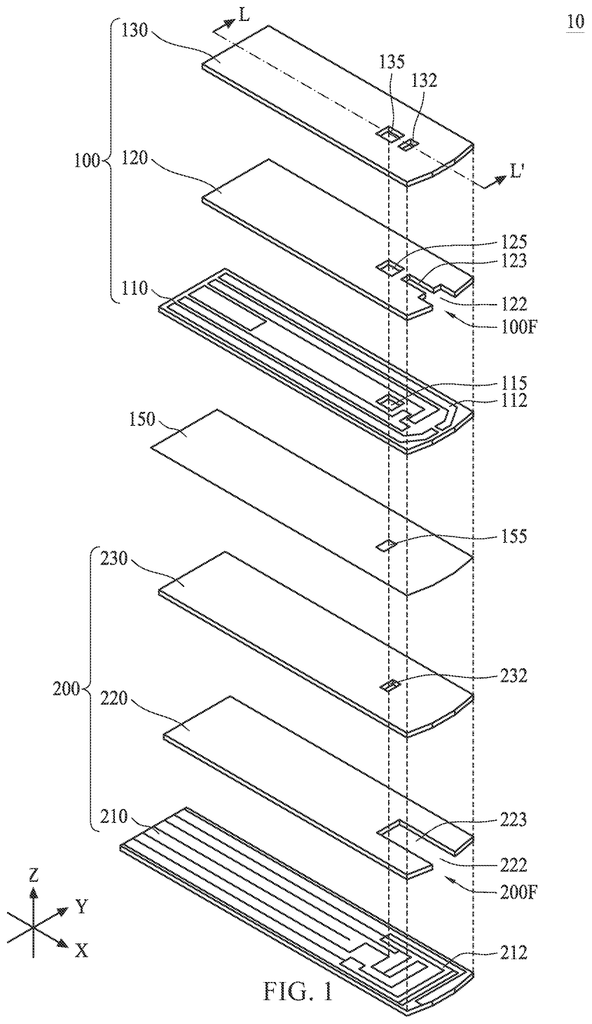

Conventional stacked biochemical test modules have the lower reaction piece blocked by the upper reaction piece due to the stacking of the upper and lower reaction pieces, which prevents the smooth removal of gas from the lower reaction piece and prevents the user from observing the sampling state of the samples in the lower reaction piece. The present disclosure proposes a biochemical test module to address the above problems. Various embodiments of the present disclosure will be discussed hereinafter with reference to FIG. 1 to FIG. 12.

Referring to FIG. 1; FIG. 1 is an exploded schematic diagram illustrating a biochemical test module 10 according to some embodiments of the present disclosure. The biochemical test module 10 may be a biochemical test chip or an electrochemical test chip, which is a device capable for providing a chemical reaction. In some embodiments, the biochemical test module 10 includes a first reaction piece 100, an adhesive layer 150 and a second reaction piece 200. In some other embodiments, the biochemical test module 10 includes a plurality of reaction pieces and an adhesive layer disposed between the plurality of reaction pieces.

In some embodiments, the first reaction piece 100 includes a first substrate 110, a first separator 120 and a first cover 130; and the second reaction piece 200 includes a second substrate 210, a second separator 220 and a second cover 230. In some embodiments, the respective material of the first substrate 110 and the second substrate 210 may be polyethylene (PE), polypropylene (PP), poly vinyl chloride (PVC), polycarbonate (PC), polyethylene terephthalate (PET), polystyrene (PS), polyolefin (PO), polyimide (PI), polyurethane (PU), polyethylene naphthalate (PEN), polyethersulfone (PES), ethylene vinyl acetate (EVA), glass plate, ceramics, glass fiber (FR-4), polyester sulphone, bakelite, or any combination of the foregoing; however, the present disclosure is not limited thereto. The material of the first substrate 110 and the second substrate 210 can be adjusted depending on actual needs.

In some embodiments, the first substrate 110 includes a first conductive structure 112, which is disposed on the surface of the first substrate 110 or within the first substrate 110; and the second substrate 210 includes a second conductive structure 212, which is disposed on the surface of the second substrate 210 or within the second substrate 210. In some embodiments, the respective material of the first conductive structure 112 and the second conductive structure 212 may be a conductive material, such as palladium, platinum, aluminum, gold, titanium, carbon, silver, copper, or any combination of the foregoing. Shapes of the first conductive structure 112 and the second conductive structure 212 are not limited in the present disclosure, and the first conductive structure 112 and the second conductive structure 212 may have any shapes. In some embodiments, the first conductive structure 112 and the second conductive structure 212 form an electrode unit, such as a working electrode or counter electrode; however, the present disclosure is not limited thereto, and the first conductive structure 112 and the second conductive structure 212 may be individually used as different electrodes depending on actual needs. In some embodiments, the first substrate 110 has a connection port 115, wherein the connection port 115 is located at a position within the first substrate 110 and penetrates through the first substrate 110. In some embodiments, the connection port 115 is separated from the first conductive structure 112.

In some embodiments, the materials of the first separator 120 and the second separator 220 are insulating materials, such as polyvinyl chloride (PVC), polyethylene terephthalate (PET), heat-drying insulating paints or UV-curable insulating paints, etc.; however, the present disclosure is not limited thereto, and the respective material of the first separator 120 and the second separator 220 may be adjusted depending on actual needs. In some embodiments, the first separator 120 has a first sampling port 122, a first notch 123 and a connection port 125. In some embodiments, the first sampling port 122 is disposed at one side of the first separator 120 to expose a portion of the inner surface of the first separator 120. The opening direction of the first reaction piece 100 at the first sampling port 122 may be referred to as the first front end 100F of the first reaction piece 100. In some embodiments, the connection port 125 is located at a position within the first separator 120 and penetrates through the first separator 120, and the first notch 123 is located between the first sampling port 122 and the connection port 125. In some embodiments, the first notch 123 in connection with the first sampling port 122 but is separated from the connection port 125. In some embodiments, the position of the connection port 125 of the first separator 120 is aligned with the position of the connection port 115 of the first substrate 110 in the vertical direction Z. In some embodiments, the second separator 220 has a second sampling port 222 and a second notch 223. In some embodiments, the second sampling port 222 is disposed at one side of the second separator 220 to expose a portion of the inner surface of the second separator 220. The opening direction of the second reaction piece 200 at the second sampling port 222 may be referred to as the second front end 200F of the second reaction piece 200. In some embodiments, the second notch 223 is in connection with the second sampling port 222.

In some embodiments, the material of the first cover 130 and the second cover 230 is an insulating material, including, for example, PVC, PET, heat-drying insulating paints or UV-curable insulating paints, or the like; however, the present disclosure is not limited thereto, and the materials of the first cover 130 and the second cover 230 may be adjusted respectively depending on actual needs. In some embodiments, the first cover 130 and the second cover 230 are made of transparent or translucent material. In some embodiments, the first cover 130 has a first hole 132 and a connection port 135, wherein the first hole 132 and the connection port 135 are separated from each other. The first hole 132 and the connecting opening 135 are each positioned at a location within and penetrating through the first cover 130, respectively. In some embodiments, the location of the first hole 132 is aligned with the location of the first notch 123 in a vertical direction Z. In some embodiments, the location of the connecting opening 135 of the first cover 130 is aligned with the location of the connecting port 125 of the first separator 120 in the vertical direction Z. In some embodiments, the second cover 230 has a second hole 232. The second hole 232 is positioned within and penetrating through the second cover 230. In some embodiments, the first hole 132 and the second hole 232 are venting structures that can be used for venting gases generated during testing or air originally in the first notch 123 or the second notch 223 (more details are described in following paragraphs).

In some embodiments, the adhesive layer 150 has a connection port 155, wherein the connection port 155 is located at a position within the adhesive layer 150 and penetrating the adhesive layer 150. In some embodiments, the position of the connection port 155 of the adhesive layer 150 is aligned with the position of the connection port 115 of the first substrate 110 and the position of the second hole 232 of the second cover 230 in the vertical direction Z. In some embodiments, the adhesive layer 150 is made of transparent or translucent material. The adhesive layer 150 may include solid or liquid adhesive materials, such as polyvinyl alcohol, polyvinyl acetate, acrylonitrile, epoxy compounds, UV-curable resins, or any combination of the foregoing; however, the present disclosure is not limited thereto.

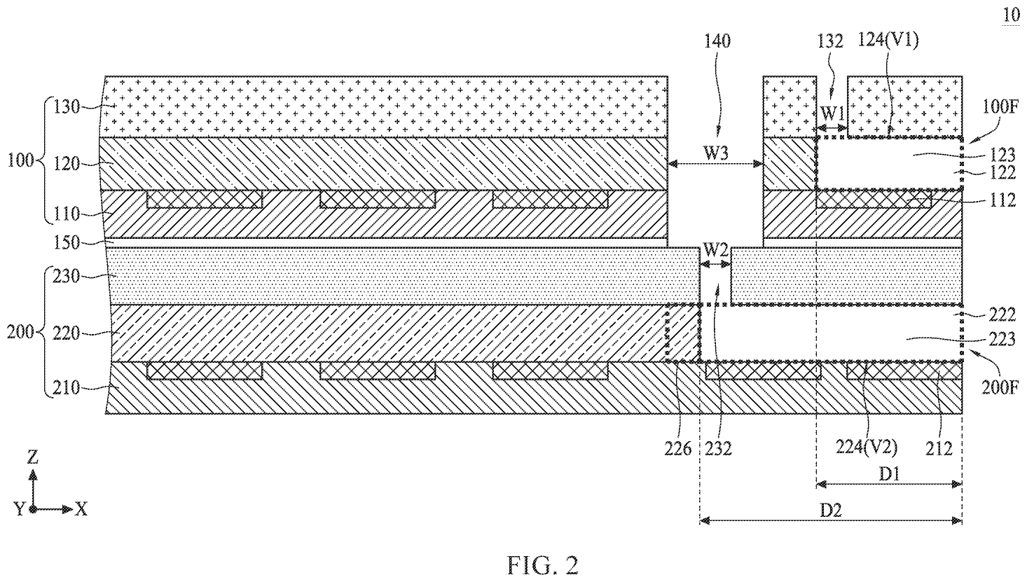

Referring to FIG. 2; FIG. 2 is a cross-sectional view of the biochemical test module 10 according to the embodiment shown in FIG. 1 taken along the line L-L′. In some embodiments, the first separator 120 of the first reaction piece 100 is disposed on the first substrate 110, whereas the first cover 130 is disposed on the first separator 120. In some embodiments, the second separator 220 of the second reaction piece 200 is disposed on the second substrate 210, whereas the second cover 230 is disposed on the second separator 220. In some embodiments, the first reaction piece 100 of the biochemical test module 10 is disposed on the second reaction piece 200 and is bonded to the second reaction piece 200 via the adhesive layer 150. The adhesive layer 150 is disposed between the lower surface of the first substrate 110 and the upper surface of the second cover 230. The first sampling port 122 of the first reaction piece 100 and the second sampling port 222 of the second reaction piece 200 are vertically aligned and stacked.

In some embodiments, the first sampling port 122 and the first notch 123 form a first flow channel 124 in the space encapsulated by the first substrate 110, the first separator 120 and the first cover 130, wherein the first flow channel 124 exposes at least a portion of the first substrate 110. In some embodiments, the first flow channel 124 exposes at least a portion of the first conductive structure 112 on the first substrate 110. The first flow channel 124 has a first flow channel length D1 in a longitudinal direction X and has a first flow channel width (not shown in the drawing) in a transverse direction Y. In some embodiments, the first flow channel length D1 is the straight line distance in longitudinal direction X from the first front end 100F to the first hole 132, i.e., the straight line distance from the first front end 100F to the innermost portion of the first notch 123. In some embodiments, the second flow channel length D2 is the straight line distance in longitudinal direction X from the second front end 200F to the second hole 232, i.e., the straight line distance from the second front end 200F to the innermost portion of the second notch 223. The first flow channel 124 has a first flow channel volume V1, the size of which is determined according to the first flow channel length D1, the width of the first flow channel and the thickness of the first separator 120. In some embodiments, the first flow channel 124 is in connection with the first hole 132 of the first cover 130.

In some embodiments, the second sampling port 222 and the second notch 223 form a second flow channel 224 in the space encapsulated by the second substrate 210, the second separator 220 and the second cover 230, wherein the second flow channel 224 expose at least a portion of the second substrate 210. In some embodiments, the second flow channel 224 exposes at least a portion of the second conductive structure 212 on the second substrate 210. The second flow channel 224 has a second flow channel length D2in the longitudinal direction X and has a second flow channel width (not shown in the drawing) in the transverse direction Y. The second flow channel 224 has a second flow channel volume V2, the size of which is determined according to the second flow channel length D2, the width of the second flow channel and the thickness of second separator 220. In some embodiments, the second flow channel 224 is in connection with the second hole 232 of the second cover 230. In some embodiments, the first flow channel 124 of the first reaction piece 100 and the second flow channel 224 of the second reaction piece 200 are independent from each other and not in connection with each other.

In some embodiments, the first flow channel length D1 of the first reaction piece 100 is different from the second flow channel length D2 of the second reaction piece 200; for example, the second flow channel length D2 is greater than the first flow channel length D1, however, the relative dimension of the width of the first flow channel and the width of the second flow channel is not particularly limited. Therefore, it is feasible to adjust the dimension of the width of the first flow channel and/or the width of the second flow channel depending on actual needs such that the first flow channel volume V1 is greater than, equal to or less than the second flow channel volume V2.

In some embodiments, the connection port 135 of the first cover 130, the connection port 125 of the first separator 120, the connection port 115 of the first substrate 110 and the connection port 155 of the adhesive layer 150 shown in FIG. 1 are connected to form a perforated structure 140, as shown in FIG. 2. The perforated structure 140 penetrates downwardly from the first cover 130 to the first separator 120, the first substrate 110 and the adhesive layer 150, and exposes at least a portion of the second cover 230 of the second reaction piece 200. In some embodiments, the perforated structure 140 is separated from the first hole 132 and the first flow channel 124. In some embodiments, the perforated structure 140 is in connection with the second flow channel 224 via the second hole 232. In some embodiments, at least a portion of the second flow channel 224 overlaps the perforated structure 140 in the vertical direction Z and is exposed by the perforated structure 140; for example, the second substrate 210 and the second conductive structure 212 of the second flow channel 224 are exposed by the perforated structure 140. In some embodiments, the width W3 of the perforated structure 140 is greater than the width W1 of the first hole 132 and the width W2 of the second hole 232. Since the width W3 of the perforated structure 140 is greater than the width W2 of the second hole 232, so that the second hole 232 is exposed by the perforated structure 140, when the samples in the second flow channel 224 undergoes a chemical reaction during testing gases may be generated, which are able to be smoothly discharged from the second hole 232 via the perforated structure 140. In some embodiments, the perforated structure 140 also has the function of helping a user observe the sample in the second reaction piece 200. The use of the perforated structure 140 will be described in more detail below.

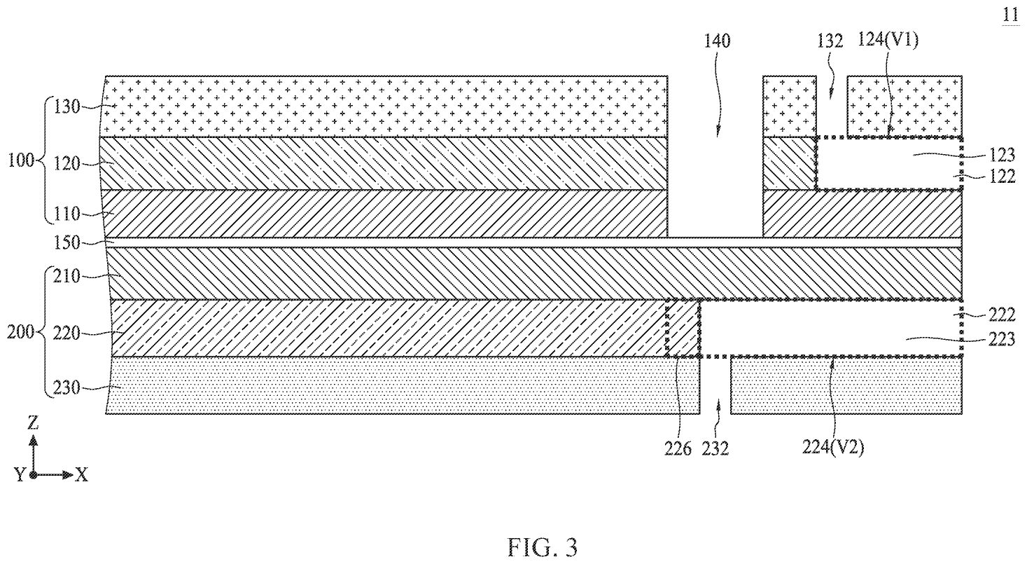

Referring to FIG. 3, FIG. 3 is a cross-sectional view illustrating a biochemical test module 11 according to some embodiments of the present disclosure. The components of the biochemical test module 11 are basically the same as the components of the biochemical test module 10, and for the sake of clarity, the labeling of some of the components in FIG. 3 is omitted. The biochemical test module 11 differs from the biochemical test module 10 in that the second substrate 210, the second separator 220 and the second cover 230 in the second reaction piece 200 of the biochemical test module 11 are stacked in a different order than the second substrate 210, the second separator 220 and the second cover 230 in the second reaction piece 200 of the biochemical test module 10. In some embodiments, the stacking order of the second reaction piece 200 the biochemical test module 11 is in the reverse order of the stacking order of the second reaction piece 200 of the biochemical test module 10. In other words, the first substrate 110 and the second substrate 210 of the biochemical test module 11 are adjacent to each other, and the adhesive layer 150 is disposed between the lower surface of the first substrate 110 and the upper surface of the second substrate 210. In such an embodiment, the opening direction of the first hole 132 of the first cover 130 is opposite to the opening direction of the second hole 232 of the second cover 230. In some embodiments, the perforated structure 140 penetrates downwardly from the first cover 130 to the first separator 120 and the first substrate 110, and exposes at least a portion of the adhesive layer 150. In some embodiments, the perforated structure 140 and the second flow channel 224 are separated by the adhesive layer 150 and the second substrate 210. In some embodiments, at least a portion of the second separator 220 overlaps the perforated structure 140 along the vertical direction Z. In some embodiments, the second substrate 210 is made of transparent or at least translucent material.

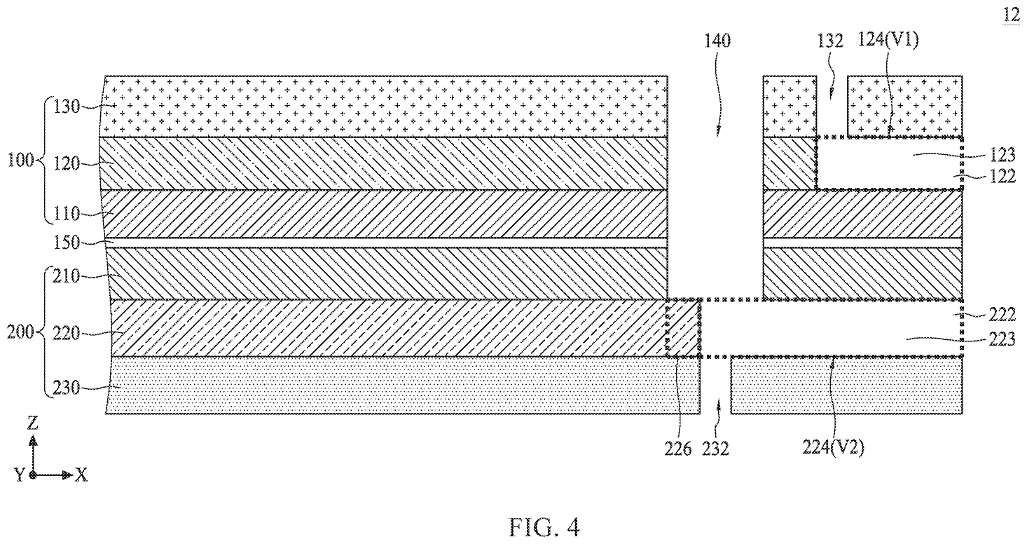

Referring to FIG. 4, FIG. 4 is a cross-sectional view illustrating a biochemical test module 12 according to some other embodiments of the present disclosure. The components of the biochemical test module 12 are basically the same as the components of the biochemical test module 10 or 11, and for the sake of clarity, the labeling of some of the components in FIG. 4 is omitted. The biochemical test module 12 is similar to biochemical test module 11 with the main difference in that the perforated structure 140 of the biochemical test module 12 penetrates through the adhesive layer 150 and the second substrate 210 of the second reaction piece 200. In the present embodiment, the perforated structure 140 can be used to observe and facilitate the venting of the second reaction piece 200.

Referring to FIG. 2 to FIG. 4; in some embodiments, a portion of the structure of the second reaction piece 200 of the biochemical test modules 10, 11 or 12 can serve as a recognition zone 226. For example, a portion of the second separator 220 that overlaps the perforated structure 140 in the vertical direction Z may serve as the recognition zone 226. The use of the recognition zone 226 will be described in detail below.

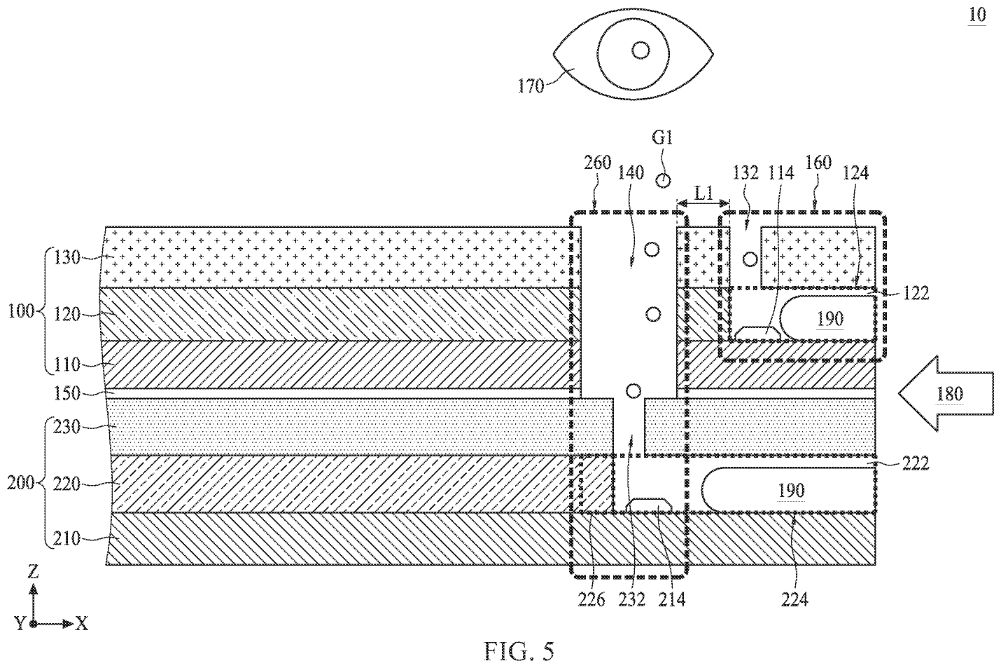

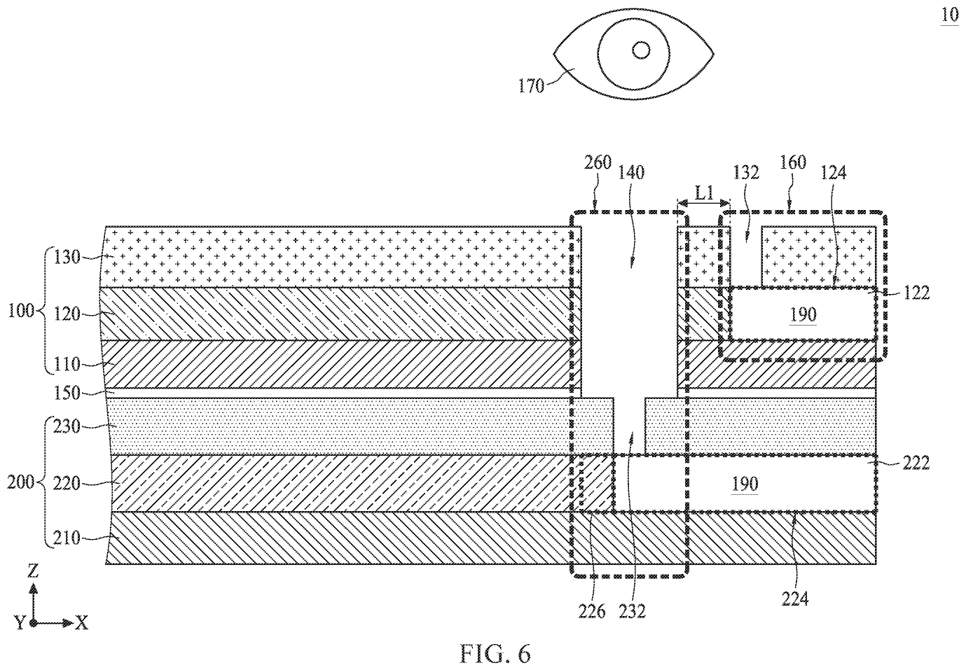

FIG. 5 and FIG. 6 are schematic diagrams illustrating a biochemical test module 10 according to some embodiments of the present disclosure during use. The biochemical test module 10 is used to collect a sample 190 and electrochemically react with it to detect a target analyte therein. The biochemical test modules 11 and 12 are used in the same or similar manner as the biochemical test module 10, and the use of the biochemical test module 10 is described below.

Referring to FIG. 5, in some embodiments, a user 170 may approach the first sampling port 122 and the second sampling port 222 to inject the sample 190 into the biochemical test module 10 for testing via any medium 180, such as a finger, other part of the body, or a dropper. In some embodiments, the sample 190 is a biological collection such as blood, tissue fluid, urine, sweat, tears, etc., but the present disclosure is not limited thereto. Furthermore, blood may include whole blood, plasma, or serum, among others, but the present disclosure is not limited thereto. In some embodiments, a first reagent 114 is disposed in the first flow channel 124 and a second reagent 214 is disposed in the second flow channel 224; the positions of the first reagent 114 and the second reagent 214 shown in FIG. 5 are only schematic, and may be disposed in different positions in the first flow channel 124 and the second flow channel 224, respectively, depending on different types of reaction pieces or test items. The first reagent 114 and the second reagent 214 are used to chemically react with components in the sample 190, which may be the same or different compounds.

In order to allow a plurality of reaction pieces to measure different parameters simultaneously without interfering with each other, the biochemical test module 10 of the present disclosure uses a plurality of reaction pieces stacked on top of each other, so that the first channel 124 and the second channel 224 are independent of each other and are not interconnected with each other, which reduces or avoids interference of signals generated by the samples 190 in the two flow channels 124 and 224 (the reaction zones), and thus improves the accuracy of the measurements, and also allows the user 170 to measure two same or different test data at the same time by simply injecting the samples 190 once.

When the liquid sample 190 comes into contact with the first reagent 114 in the first flow channel 124 and the second reagent 214 in the second flow channel 224, a chemical reaction will occur in the first flow channel 124 and the second flow channel 224, respectively. The chemical reaction, such as an oxidation-reduction reaction, will result in the transfer of electrons, and the resulting current signals may be transmitted through the first conductive structure 112 on the surface or inside of the first substrate 110 and the second conductive structure 212 on the surface or inside of the second substrate 210 (shown in FIG. 1), respectively. Since the first flow channel 124 and the second flow channel 224 are independent of each other and are not connected to each other, the current signals transmitted through the first conductive structure 112 do not interfere with the current signals transmitted through the second conductive structure 212, and thus different analyte concentrations can be detected accurately and simultaneously.

Referring to FIG. 5 and FIG. 6, the liquid sample 190 gradually fills the first flow channel 124 and the second flow channel 224. There is a gas G1 (e.g., air) in the first flow channel 124 and the second flow channel 224, which is squeezed as the sample 190 fills in. In some embodiments, the first hole 132 and the second hole 232 may ventilate the gas G1 under the squeezing by the sample 190 so that the sample 190 can continue to flow into the interior of the first flow channel 124 and the second flow channel 224. In some other embodiments, gas G1 generated in the first flow channel 124 or the second flow channel 224 as a result of a biochemical reaction between the sample 190 and the first reagent 114 or the second reagent 214 may also be ventilated by the first hole 132 and the second hole 232. In some embodiments, gas G1 may diffuse from the second hole 232 to the perforated structure 140 to exit the biochemical test module 10.

In some embodiments, the biochemical test module 10 has a first viewing zone 160 and a second viewing zone 260. The first viewing zone 160 corresponds to the first flow channel 124 of the first reaction piece 100, e.g., a portion of the first flow channel 124 viewed through the first cover 130 or the first hole 132, wherein the first viewing zone 160 exposes at least a first terminal of the first flow channel 124 (i.e., an interior wall of the first separator 120). The second viewing zone 260 corresponds to the second flow channel 224 of the second reaction piece 200, e.g., a portion of the second flow channel 224 viewed through the perforated structure 140, the second cover 230 or the second hole 232, wherein the second viewing zone 260 exposes at least a second terminal of the second flow channel 224 (.c., an interior wall of the second separator 220). Since the first cover 130 and the second cover 230 are transparent or translucent, the first viewing zone 160 and the second viewing zone 260 are see-through areas, and the user 170 can respectively observe the sampling state in the first flow channel 124 via the first viewing zone 160 and observe the sampling state in the second flow channel 224 via the second viewing zone 260. In some embodiments, the perforated structure 140 of the first reaction piece 100 exposes the second viewing zone 260. In the X-Y direction, the area of the perforated structure 140 is greater than or equal to the area of the second viewing zone 260, so that the user 170 can observe the injection of the sample 190 in the second flow channel 224 in the second viewing zone 260 via the perforated structure 140. Thus, although the second reaction piece 200 at the lower layer is blocked by the first reaction piece 100, the flow of the sample 190 in the second flow channel 224 of the second reaction piece 200 can still be observed.

In order to allow the user 170 to more clearly view the sampling state of the second viewing zone 260 from the perforated structure 140, the second viewing zone 260 exposes the recognition zone 226, which allows the user 170 to more clearly recognize the injection state of the sample 190 by the visual contrast between the sample 190 and the recognition zone 226. In some embodiments, the recognition zone 226 is a portion of the structure of the second reaction piece 200, and the visual contrast between the sample 190 and the recognition zone 226 makes it easier for the user 170 to clearly observe the injection of the sample 190 to determine whether or not it is necessary to add more samples 190 to the sample, and thus enhance the accuracy of the detection.

Take the example where the recognition zone 226 is a portion of the structure of the second reaction piece 200, the recognition zone 226 may be part of the second cover 230 or the second separator 220, and the recognition zone 226 may be translucent or opaque, and in a preferred embodiment, the recognition zone 226 is opaque. Since the second viewing zone 260 exposes the recognition zone 226, when the sample 190 enters and flows into the second viewing zone 260 from the first sampling port 122 and the second sampling port 222, the sample 190 and the recognition zone 226 will produce an obvious visual contrast, and the user 170 will be able to visually recognize the injection state of the sample 190; in other words, when the sample 190 fills up the second viewing zone 260, the user 170 will visually highlight the exposed the recognition zone 226 of the second viewing zone 260 to achieve the effect of clearly recognizing the entry of the sample 190, so that the user 170 can visually determine whether it is necessary to further add the sample 190, thereby further enhancing the accuracy of the measurement.

In some other embodiments, the recognition zone 226 is a component other than the first reaction piece 100 or the second reaction piece 200; for example, the recognition zone 226 may be a marking or scribing (or the like) on the first reaction piece 100 or the second reaction piece 200 that is different from the color of the sample 190. Various forms of markings may be defined as the recognition zone 226 as long as they allow the user 170 to clearly recognize visually the injection of the sample 190 into the first flow channel 114 and the second flow channel 224.

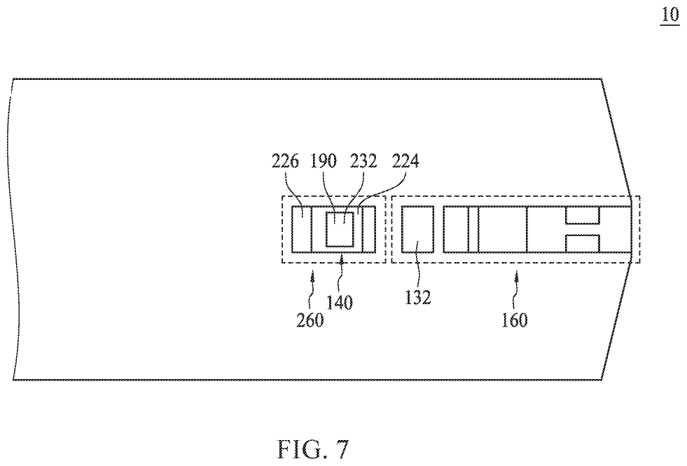

FIG. 7 is a top view of the biochemical test module 10 according to the embodiment shown in FIG. 6 after sample 190 filling. In some embodiments, the second viewing zone 260 exposes the recognition zone 226, and the recognition zone 226 is translucent or opaque, so that when the sample 190 in the second flow channel 224 is filled up, the sample 190 exposed in the second viewing zone 260 and the recognition zone 226 will produce a visual contrast, and thus the user 170 can judge that the sample 190 has been injected by visually observing the recognition zone 226, thus minimizing the measurement difference caused by the error of judgment. The location of the recognition zone 226 is not limited to that shown in FIG. 7, as long as the flow channel state can be observed in the second viewing zone 260, and the visual recognition can be achieved, it is within the scope of protection of the present disclosure. In some embodiments, the shape of the second viewing zone 260 may be elliptical, triangular, rhombic, etc., and different shapes of the viewing zone may expose different states of the recognition zone 226, as long as it allows the user 170 to visually recognize the injection state of the sample 190, it is within the scope of protection of the present disclosure.

Referring to FIGS. 6 and 7, in order to allow the user 170 to visually recognize the first flow channel 124 and the second flow channel 224, the first terminal cannot see through the second terminal, and in the case where the first flow channel 124 and the second flow channel 224 are not visually interfering with each other, the user 170 can observe the sampling states of the two flow channels 124 and 224 via the first viewing zone 160 and the second viewing zone 260, respectively, so as to reduce the visual interference caused by the first flow channel 124 and the second flow channel 224 being able to see through each other, thereby reducing the measurement error caused by the user 170 misjudging the sampling state. In addition, in order to enable the user 170 to clearly recognize the flow state of the samples 190 in the first viewing zone 160 and the second viewing zone 260, the first viewing zone 160 and the second viewing zone 260 are separated by a spacing distance L1 in the longitudinal direction X, i.e., the first viewing zone 160 and the second viewing zone 260 are visually separated by a distance that does not visually overlap and interfere with each other, reducing any error of interpreting the sampling status caused by visual interference during observation by the user 170. In some embodiments, the spacing distance L1 between the first viewing zone 160 and the second viewing zone 260 of the biochemical test module 10 may be greater than or equal to 0.6 mm, preferably greater than or equal to 0.5 mm; this allows the user 170 to observe the sampling states in the first viewing zone 160 and the second viewing zone 260 with less visual interference, thereby enhancing the accuracy of the user 170 in judging the injection state of the sample 190.

In some embodiments, when the first viewing zone 160 and the second viewing zone 260 have the same shape, the state of the two viewing zones 160, 260 can be recognized by the size of the spacing distance L1. In some other embodiments, the degree of visual difference between the two viewing zones 160, 260 can also be enhanced by adjusting the shapes of the first viewing zone 160 and the second viewing zone 260. The shapes of the first viewing zone 160 and the second viewing zone 260 are different, and the first viewing zone 160 and the second viewing zone 260 are, for example, quadrilateral, square, circular, elliptical, triangular, and so on; for example, the first viewing zone 160 is rectangular, and the second viewing zone 260 is triangular, and due to the difference in the shapes of the first viewing zone 160 and the second viewing zone 260; due to the different shapes of the first viewing zone 160 and the second viewing zone 260, when the sample 190 enters the viewing zone, the user 170 can observe the flow state of the sample 190 from the first viewing zone 160 and the second viewing zone 260 of different shapes, respectively, so as to enhance the visual difference between the two viewing zones 160 and 260, and to reduce the measurement error due to misjudgment.

In addition to reducing visual interference by utilizing the difference in shape of the first viewing zone 160 and the second viewing zone 260, differences in color or graphic markings can be used to increase the visual differentiation of the two viewing zones 160, 260. The first viewing zone 160 and the second viewing zone 260 may have the same or different color markings, for example, the borders of the first viewing zone 160 and the second viewing zone 260 have color markings that are different from the color of the sample 190, so that when the sample 190 is injected, the sample 190 will visually contrast with the color markings of the first viewing zone 160 and the second viewing zone 260. The sample 190, for example, is blood, and utilizing the green marking to produce visual contrast with respect to red blood further enhances the visual recognition of the user 170. Moreover, in order to enhance the visual recognition of the first viewing zone 160 and the second viewing zone 260, the color of the second reaction piece 200 exposed to the second viewing zone 260 is different from the color of the sample 190; in a preferred embodiment, the colors of the first reaction piece 100, the recognition zone 226 exposed to the second viewing zone 260, and the sample 190 are different, so that the combination of different colors produces an obvious contrast after the sample 190 is injected so as to reduce visual interference, and thus enhances the degree of recognition by the user 170 to recognize whether the sample 190 has been injected. In another embodiment, the colors of the first reaction piece 100, the recognition zone 226 exposed to the second viewing zone 260 are the same but different from the color of the sample 190. The above mentioned color differences of the reaction piece, the recognition zone 226 and the sample 190 are not limited to those enumerated above, as long as they are recognizable by the user 170 during the observation process, they are all within the scope of protection of the present disclosure.

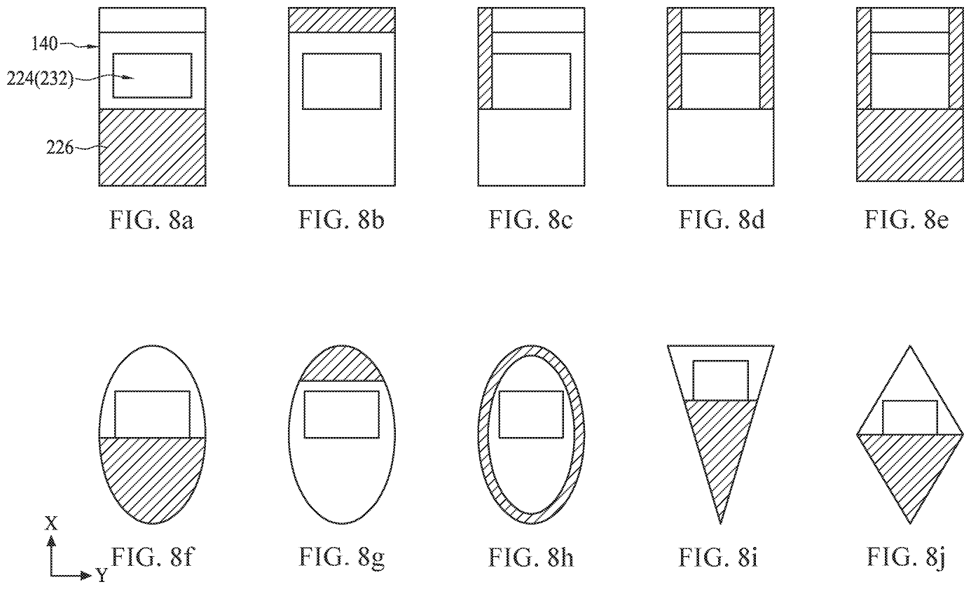

FIGS. 8a to 8j are top views of the second viewing zone 260 of the biochemical test module 10 according to the embodiment shown in FIG. 6 when the sample is not filled with the sample 190, showing the recognition zone 226 presented through the perforated structure 140. When a user 170 looks down at the perforated structure 140 of the biochemical test module 10 or 11, since the second cover 230 and the second substrate 210 are transparent or translucent, the area of the second separator 220 overlapping the perforated structure 140 can be seen from the perforated structure 140, and that portion of the second separator 220 will have a distinct visual contrast with the sample 190 filled in the second flow channel 224, and is thus referred to as the recognition zone 226. In some embodiments, the top view of the perforated structure 140 may have different shapes, such as square, quadrilateral circle, ellipse, triangle, diamond, or other irregular geometric shapes. In some embodiments, the top view of the recognition zone 226 may have a different shape, such as a square, quadrilateral, circle, ellipse, triangle, rhombus, bow, fan, ring, or other irregular geometry.

Referring to FIG. 8a, taking the rectangular perforated structure 140 as an example, the recognition zone 226 of the exposed second viewing zone 260 may be a portion of the structure of the second cover 230 or the second separator 220, and the recognition zone 226 may be located on at least one side of the second viewing zone 260.

In some embodiments, the location of the recognition zone 226 may be located on a single side of the second viewing zone 260, for example: when the recognition zone 226 is the second cover 230, the recognition zone 226 may be located near the connection terminal (e.g., FIG. 8a), near the sampling ports 122, 222 (e.g., FIG. 8b), or on the other side (e.g., FIG. 8c); when the recognition zone 226 is the second separator 220, the recognition zone 226 may be located near the connection terminal (as in FIG. 8a).

In some other embodiments, the location of the recognition zone 226 may be located on multiple sides of the second viewing zone 260, e.g., when the recognition zone 226 is the second cover 230, the recognition zone 226 may be located on two sides (e.g., FIG. 8d), on three sides (e.g., FIG. 8c), or at the perimeter of the second viewing zone 260 (not shown in the drawing). In the case of an elliptical perforated structure 140, for example, the recognition zone 226 exposed at the second viewing zone 260 may be a portion of the structure of the second cover 230 or the second separator 220, and the recognition zone 226 may be located on a single side of the second viewing zone 260, e.g., in adjacent to a connecting terminal (e.g., FIG. 8f), in adjacent to the sampling ports 122, 222 (e.g., FIG. 8g), or at a periphery of the second viewing zone 260 (e.g., FIG. 8h). The perforated structure 140 may also be shaped in various geometries such as triangular (e.g., FIG. 8i) or rhombus (e.g., FIG. 8j), and the present disclosure is not limited to those exemplified.

Taking the embodiment of FIG. 8f as an example, the perforated structure 140 is elliptical, the second viewing zone 260 is partially elliptical, the recognition zone 226 exposed to the second viewing zone 260 is the second cover 230, and the recognition zone 226 is an opaque area. According to the Gestalt school of thought, when the user 170 observes the flow of the sample 190 into the second viewing zone 260 through the elliptical perforated structure 140, the user will consciously perceive that the sample 190 will visually appear in a complete elliptical shape after filling up; however since the recognition zone 226 exposed to the second viewing zone 260 is a translucent or opaque area, the user 170 will visually perceive that the sample 190 does not completely fill up the elliptical shape, and the user 170 will therefore be confused and unconsciously check the sampling state of the second viewing zone 260 again, thereby achieving the effect of enhancing the user 170's observation of the second viewing zone 260.

In another embodiment, the perforated structure 140 is triangular (as shown in FIG. 8i), and a person would cognitively think that the second viewing zone 260 should be completely triangular after the sample 190 fills up the second viewing zone 260; however, because the recognition zone 226 is exposed to the second viewing zone 260, the sample 190 flow stops at recognition zone 226, thereby showing an imperfect triangular; thus, a person will check again the second viewing zone 260 after having doubts on what he have seen, thereby achieving the effect of allowing the user 170 to gaze at the viewing zone. However, because the recognition zone 226 is exposed to the second viewing zone 260, the sample 190 flows and stops at the recognition zone 226 and appears imperfectly triangular, a person may visually doubt the second viewing zone 260 and then look at the second viewing zone 260 again, so that the user 170 can gaze at the viewing zone. In another embodiment, the perforated structure 140 is in the shape of a rhombus (as shown in FIG. 8j); the shape of the second viewing zone 260 is not limited those exemplified, as long as it can visually make the user 170 doubtful and gaze at the second viewing zone 260 again, it is within the scope of protection of the present disclosure. In addition, as long as it allows the user 170 to clearly observe the sampling state of the second reaction piece 200 through the perforated structure 140, and helps the second reaction piece 200 to ventilate to minimize the capillary phenomenon, it is within the scope of protection of the present disclosure, and there is no limitation on the shape of the perforated structure 140.

In view of the foregoing, the biochemical test module 10 or 11 includes a plurality of reaction pieces and the reaction pieces are arranged in an overlapping arrangement with each other, and the present configuration is able to reduce the mutual interference of each reaction piece during the reaction process, thereby obtaining two or more measurement values. The biochemical test module 10 has a perforated structure 140 that can see through to the lower flow channel, and the perforated structure 140 is in connection with the second hole 232, and the perforated structure 140 exposes the second viewing zone 260, which allows the user 170 to visually recognize the flow state of the sample 190 in the second flow channel 224 from the second viewing zone 260, thus solving the problems caused by the overlapping of the first reaction piece 100 and the second reaction piece 200 so that the second flow channel 224 of the lower second reaction piece 200 is blocked, thus making it impossible to directly observe the flow state of the sample 190. In addition, the perforated structure 140 also has the function of helping the second reaction piece 200 to ventilate the gas G1.

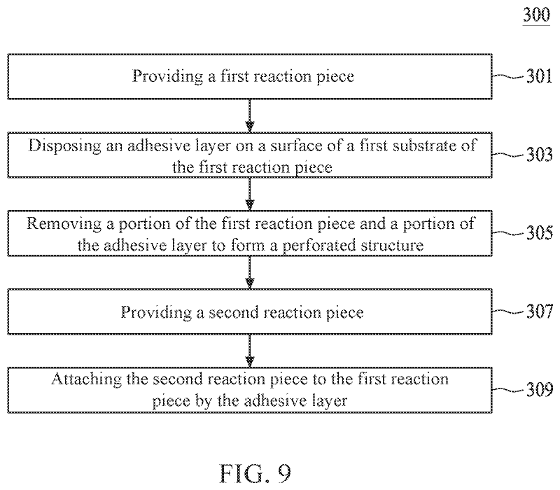

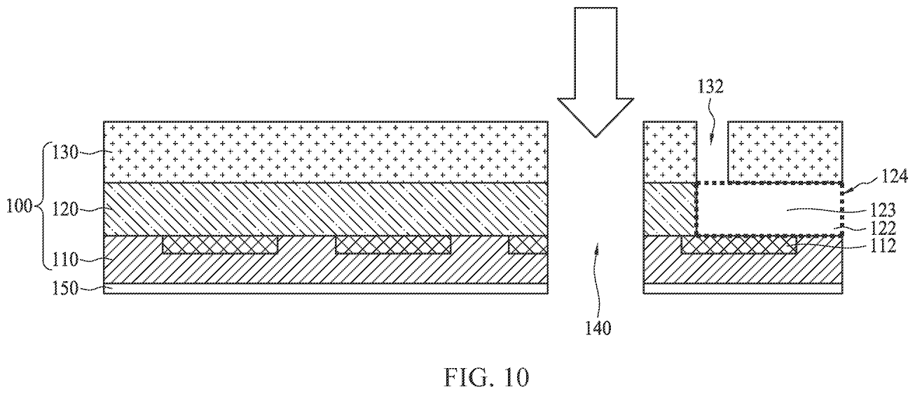

FIG. 9 is a flow chart illustrating a method 300 for manufacturing the biochemical test module 10 according to some embodiments of the present disclosure. FIGS. 10 through 12 are cross-sectional views of the various manufacturing stages illustrated in the manufacturing method 300 according to FIG. 9.

Referring to FIG. 10; FIG. 10 shows a cross-sectional view of steps 301, 303, and 305 of the manufacturing method 300. In step 301, a first reaction piece 100 is provided, the first reaction piece 100 includes at least a first substrate 110, a first separator 120, and a first cover 130. The first separator 120 covers the first substrate 110, whereas the first cover 130 covers the first separator 120. A first conductive structure 112 is provided on the surface of or within the first substrate 110, and the material of the first conductive structure 112 is, for example, a conductive adhesive such as palladium adhesive, platinum adhesive, aluminum adhesive, gold adhesive, titanium adhesive, carbon adhesive, silver adhesive, copper adhesive, or any combination of the foregoing. The formation method of the first conductive structure 112 is, for example, but not limited to, screen printing, imprinting, thermal transfer printing, spin coating, ink-jet printing, laser ablation, deposition, or electrodeposition. The first separator 120 has a first sampling port 122 and a first notch 123 in connection with the first sampling port 122. The first sampling port 122 is disposed on the front side of the first separator 120 to expose a portion of the inner surface of the first separator 120. The first cover 130 is made of a transparent or translucent material. The first cover 130 has a first hole 132 that penetrate the first cover 130. The first sampling port 122 and the first notch 123 form a first flow channel 124 in the space encapsulated by the first substrate 110, the first separator 120, and the first cover 130. The first flow channel 124 exposes at least a portion of the first substrate 110 and at least a portion of the first conductive structure 112. The first flow channel 124 is in communication with a first hole 132 of the first cover 130.

In step 303, an adhesive layer 150 is disposed on a surface of the first substrate 110 of the first reaction piece 100, as shown in FIG. 10. Specifically, the adhesive layer 150 is disposed on the surface of the first substrate 110 that is opposite to the first separator 120. The adhesive layer 150 includes a solid or liquid adhesive material, such as a polyvinyl alcohol, a polyvinyl acetate, an acrylonitrile, an epoxy compound, a UV-curable resin, or any combination of the foregoing, but the present disclosure is not limited thereto.

In step 305, a portion of the first reaction piece 100 and a portion of the adhesive layer 150 are removed to form a perforated structure 140, as shown in FIG. 10. The formation of the perforated structure 140 may be performed using, but is not limited to, punching, laser engraving, hole-pressing, tumbling or hobbing. However, a better way to form the perforated structure 140 of the present disclosure is to use punching because punching utilizes pressure to form a specific shape and structure of an object, so the use of punching is more capable of accurately punching the shape of the perforated structure 140, and it is less likely to damage the original structure of the first reaction piece 100 during the operation process. The perforated structure 140 penetrates through the first cover 130, the first separator 120, the first substrate 110, and the adhesive layer 150. The perforated structure 140 is separated from the first hole 132 and the first flow channel 124. In some other embodiments, the order of steps 303 and 305 may be reversed, for example, a portion of the first reaction piece 100 may be removed first to form the perforated structure 140, and then a solid or liquid adhesive material may be applied to the surface of the first substrate 110 that is opposite to the first separator 120 to form the adhesive layer 150. In some other embodiments, a connection port (such as the connection port 155 shown in FIG. 1) is formed in a film-like adhesive layer 150 in advance, wherein the connection port 155 has an aperture area that is substantially larger than or equal to the aperture area of the perforated structure 140, and then the adhesive layer 150 with the connection port 155 is bonded to the surface that is opposite to the surface of the first separator 120. In such an embodiment, when the first reaction piece 100 and the adhesive layer 150 are bonded in an aligned manner, the projection of the perforated structure 140 falls within the projection of the connection port 155.

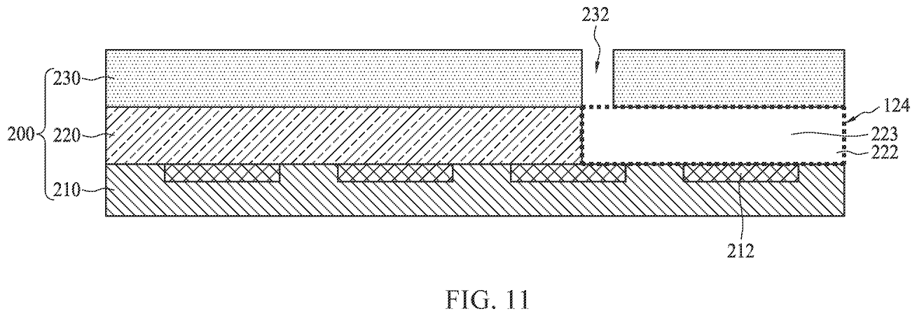

Referring to FIG. 11, FIG. 11 shows a cross-sectional view of step 307 of the manufacturing method 300. In step 307, a second reaction piece 200 is provided, the second reaction piece 200 includes at least a second substrate 210, a second separator 220, and a second cover 230. The second separator 220 covers the second substrate 210, whereas the second cover 230 covers the second separator 220. A second conductive structure 212 is provided on a surface of the second substrate 210 or inside the second substrate 210, and a material and a method of forming the second conductive structure 212 may be the same or similar to the material and method of forming the first conductive structure 112. The material and formation method of the second conductive structure 212 may be the same or similar to the material and formation method of the first conductive structure 112. The second separator 220 has a second sampling port 222 and a second notch 223 in connection with the second sampling port 222. The second sampling port 222 is disposed on the front side of the second separator 220 to expose a portion of the inner surface of the second separator 220. The second cover 230 is made of a transparent or translucent material. The second cover 230 has a second hole 232 that penetrates through the second cover 230. The second sampling port 222 and the second notch 223 form a second flow channel 224 in the space encapsulated by the second substrate 210, the second separator 220, and the second cover 230. The second flow channel 224 exposes at least a portion of the second substrate 210 and at least a portion of the second conductive structure 212. The second flow channel 224 is in connection with the second hole 232 of the second cover 230.

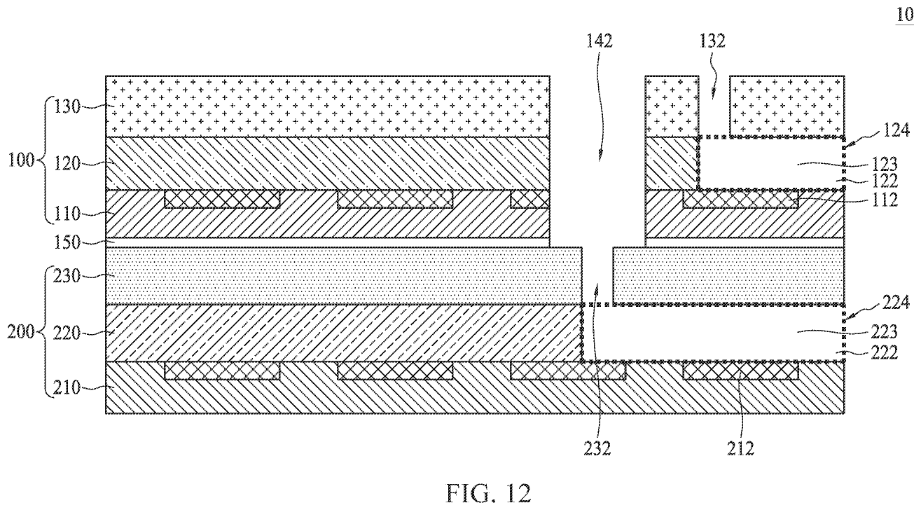

Referring to FIG. 12; FIG. 12 shows a cross-sectional view of step 309 of the manufacturing method 300. In step 309, the second reaction piece 200 is attached to the first reaction piece 100 by the adhesive layer 150. Before bonding the first reaction piece 100 to the second reaction piece 200, the first sampling port 122 of the first reaction piece 100 and the second sampling port 222 of the second reaction piece 200 need to be vertically aligned, and the second hole 232 of the second cover 230 needs to be positioned within the vertical projection of the first reaction piece 100. When the first reaction piece 100 and the second reaction piece 200 are bonded by the adhesive layer 150, the adhesive layer 150 is located between the lower surface of the first substrate 110 and the upper surface of the second cover 230. Next, a detection reagent may be disposed in the first reaction piece 100 and the second reaction piece 200, respectively. The detection reagents may be disposed at different positions in the first flow channel 124 and the second flow channel 224, depending on different types of reaction pieces or test items. The detection reagent disposed in the first flow channel 124 and the detection reagent disposed in the second flow channel 224 may be the same or different reagents used to provide biochemical assays for the same or different items, such as blood lipids, cholesterol, triglycerides, blood glucose, or electrolytes; however, the present disclosure is not limited thereto.

The biochemical test module of the present disclosure includes a plurality of reaction pieces, and each of the reaction pieces has an independent detection function and is capable of measuring the parameter values of different samples, and each of the reaction pieces has an independent detection function, and the stacking of the plurality of reaction pieces is capable of forming a biochemical test module which is capable of detecting the parameters of a plurality of samples at the same time. According to the concept of modularization by persons having ordinary skill in the art, modularization refers to the formation of a module with a specific function from a number of functional base elements, each of which is independent of a specific function, and by means of which a number of base elements can be used to form a system, device, or program with a complete function. For example, in the case of a biochemical detection module, the first reaction piece and the second reaction piece are base elements with independent functions, and by stacking the first reaction piece and the second reaction piece to form a biochemical test module, the biochemical test module is able to obtain multiple detection values while minimizing signal interference with each other, and in addition, because the biochemical test module has a perforated structure that corresponds to the second observation area and exposes the second flow channel, a user can observe the sampling state via the first viewing zone and the second viewing zone, so that the user can observe the sampling state of the lower reaction piece that is covered by the upper reaction piece through the perforated structure; in addition, because the perforated structure is connected to the holes of the lower reaction piece, the lower reaction piece is able to ventilate gas through the perforated structure, therefore, the design of the perforated structure can solve the problem that the lower reaction piece is blocked by the upper reaction piece and cannot ventilate gas and cannot observe the injection state of the sample. Therefore, the biochemical test module of the present disclosure not only has an independent detection function for each reaction piece, but also can combine two functions to form a biochemical test module with simultaneous detection of two samples, which is more capable of being used according to the user's detection needs than an electrochemical test chip with only a single detection function.

Although the disclosure and its advantages have been described in detail, it should be understood that various modifications, substitutions and replacements can be made without departing from the spirit and scope of the present disclosure as defined by the appended claims. In addition, the scope of the present application is not limited to specific examples of processes, machines, manufactures, material components, means, methods and procedures described in the specification. Those skilled in the art can understand from the disclosure of the present application that existing or future developed processes, machinery, manufacturing, and materials that have the same functions or achieve substantially the same results as the corresponding embodiments described herein can be used according to this disclosure. Accordingly, such process, machine, manufacture, material composition, means, method, or step fall within the protection scope of the present application.

1. A biochemical test module, comprising:
a first reaction piece, comprising:
a first substrate;
a first separator, located on the first substrate and having a first flow channel exposing at least a portion of the first substrate; and
a first cover, covering the first separator and having a first hole in connection with the first flow channel,
wherein the first reaction piece has a perforated structure penetrating the first cover, the first separator and the first substrate, and the perforated structure is separated from the first flow channel and the first hole,
wherein the first reaction piece has a first viewing zone configured for viewing a portion of the first flow channel via the first cover or the first hole; and
a second reaction piece, disposed in adjacent to one side of the first reaction piece of the first substrate and comprising:
a second substrate;
a second separator, located on the second substrate and having a second flow channel exposing at least a portion of the second substrate; and
a second cover, covering the second separator and joined to the first substrate, and having a second hole, wherein the second flow channel is in connection with the perforated structure via the second hole, wherein the second reaction piece has a second viewing zone configured for viewing a portion of the second flow channel via the second cover or the second hole.

2. The biochemical test module of claim 1, wherein a spacing distance is between the first viewing zone and the second viewing zone in a longitudinal direction.

3. The biochemical test module of claim 1, wherein the perforated structure exposes at least a portion of the second cover.

4. The biochemical test module of claim 1, wherein a width of the perforated structure is greater than a width of the first hole.

5. The biochemical test module of claim 1, wherein a length of the second flow channel differs from a length of the first flow channel.

6. The biochemical test module of claim 1, wherein a length of the second flow channel is greater than a length of the first flow channel.

7. The biochemical test module of claim 1, further comprising an adhesive layer disposed between the first substrate and the second cover, wherein the perforated structure penetrates through the adhesive layer.

8. The biochemical test module of claim 1, wherein the first flow channel and the second flow channel are not communicable with each other.

9. A biochemical test module, comprising:
a first reaction piece, comprising:
a first substrate, having a first surface and a second surface opposite to the first surface;
a first separator, located on the first surface and having a first flow channel; and
a first cover, covering the first separator and having a first hole in connection with the first flow channel, wherein the first reaction piece has a perforated structure penetrating the first cover, the first separator and the first substrate; and
a second reaction piece, comprising:
a second substrate, having a third surface and a fourth surface opposite to the third surface, wherein the third surface faces the second surface;
a second separator, located on the fourth surface and having a second flow channel; and
a second cover, covering the second separator and having second hole, wherein the second hole is in connection with the second flow channel.

10. The biochemical test module of claim 9, further comprising an adhesive layer disposed between the second surface and the third surface and joining the first reaction piece and the second reaction piece.

11. The biochemical test module of claim 9, wherein the second reaction piece is aligned with the first reaction piece.

12. The biochemical test module of claim 9, wherein a sampling port of the second flow channel is vertically aligned with a sampling port of the first flow channel.

13. The biochemical test module of claim 9, wherein at least a portion of the second flow channel overlaps the second hole within the perforated structure.

14. The biochemical test module of claim 9, wherein at least a portion of the second separator overlaps the perforated structure.

15. A method for manufacturing a biochemical test module, comprising:
providing a first reaction piece, which comprises:
a first substrate, having a first surface and a second surface opposite to the first surface;
a first separator, located on the first surface and having a first flow channel exposing a first portion of the first substrate; and
a first cover, covering the first separator and having a first hole in connection with the first flow channel;
forming a perforated structure penetrating the first cover, the first separator and the first substrate;
aligning a second sampling port of a second reaction piece with a first sampling port of the first reaction piece, wherein the second reaction piece comprises:
a second substrate;
a second separator, located on the second substrate and having a second flow channel exposing a second portion of the second substrate;
a second cover, having a third surface covering the second separator and a fourth surface opposite to the third surface, and having a second hole in connection with the second flow channel, wherein the second flow channel is in connection with the perforated structure via the second hole; and
attaching the second reaction piece to the first reaction piece.

16. The method of claim 15, wherein before the forming of the perforated structure, further comprising disposing an adhesive layer on the second surface, wherein the perforated structure penetrates through the adhesive layer.

17. The method of claim 15, wherein after the forming of the perforated structure, further comprising disposing an adhesive layer on the second surface, and the second reaction piece is attached to the first reaction piece via the adhesive layer.

18. The method of claim 15, wherein the forming of the perforated structure comprises punching, laser engraving, hole-pressing or tumbling.
